(19) United States
(12) Patent Application Publication
(10) Pub. No.: US 2011/0050596 A1
(43) Pub. Date: Mar. 3, 2011

(54) TOUCH SCREEN DEVICE

(76) Inventors: Dong Sun PARK, Seoul (KR); Yeon Ho Son, Gyunggi-do (KR); Jae Kyung Kim, Gyunggi-do (KR)

(21) Appl. No.: 12/581,133

(22) Filed: Oct. 17, 2009

(30) Foreign Application Priority Data
Aug. 28, 2009 (KR) 10-2009-0080609

(51) Int. Cl. G06F 3/041

(52) U.S. Cl. 345/173

(57) ABSTRACT

Disclosed herein is a touch screen device. The touch screen device includes a touch screen panel, an image display, an injection molded support member, a vibration unit and a support frame. The touch screen panel receives a touch signal from a user. The image display is mounted under the touch screen panel to display images. The image display comprises a plurality of layers. The injection molded support member is attached at one side thereof to the periphery of the lower surface of the image display. The vibration unit is mounted under the image display. The vibration unit generates vibrations depending on the touch signal. The support frame covers the injection molded support member and the vibration unit.

### CROSS REFERENCE TO RELATED APPLICATION

This application claims the benefit of Korean Patent Application No. 10-2009-0080609, filed Aug. 28, 2009, entitled “Touch Screen Device”, which is hereby incorporated by reference in its entirety into this application.

### BACKGROUND OF THE INVENTION

1. Technical Field

The present invention relates to a touch screen device.

2. Description of the Related Art

Recently, according to requirements of consumers to enhance the convenience of using electronic products, there are an increasing number of electronic products using touch screens which allow a signal to be input in a manner wherein the presence and location of touching within a display area is detected. Touch screen devices not only include the concept of inputting a signal by touching but also include the concept of incorporating the intuitive experience of a user into an interface and of diversifying feedback.

Touch screen devices have many advantages because the size of a device can be reduced, it can be easily and simply manipulated, the specifications thereof can be easily changed, a user can easily recognize information, and it is compatible with other IT devices. Because of these advantages, touch screen devices are widely used in various fields including industry, traffic, services, medical care, mobile products, etc.

Typically, in touch screen devices, a transparent touch panel is disposed close to an image display, such as an LCD, which displays an image. A user observes the image through the touch panel and presses a desired portion of the touch panel, at which time a vibration unit applies vibration to the touch panel, thus transmitting a sensation of vibration to the user.

In a representative touch screen device according to a conventional technique, an image display is attached to a lower surface of a touch screen panel. An injection-molded support member supports the periphery of the image display, and a support frame supports the lower surface of the image display.

Typically, the image display comprises one or more layers.

A vibration unit which generates vibrations depending on external force is mounted under the support frame. Furthermore, a space is necessarily left between the image display and the support frame. Therefore, when the vibration unit vibrates, the support frame bends into the space and vibrations are in practice not satisfactorily transmitted to the image display.

As such, in the touch screen panel of the conventional technique, when the vibration unit generates vibrations, vibrational force applied to the touch screen panel through the image display may be very small, with the result that the driving efficiency of the touch screen device is reduced.

Therefore, research into a technique to be used to improve the structure of the touch screen device is required so that the driving efficiency of the vibration unit can be improved upon.

### SUMMARY OF THE INVENTION

The present invention has been made in an effort to provide a touch screen device which is constructed such that the efficiency of transmitting vibrations from a vibration unit to a touch screen panel can be maximized.

In a touch screen device according to an embodiment of the present invention, a touch screen panel receives a touch signal from a user. An image display is provided under the touch screen panel to display images. The image display comprises a plurality of layers. An injection molded support member is attached at one side thereof to the periphery of the lower surface of the image display. A vibration unit is mounted under the image display. The vibration unit generates vibrations depending on the touch signal. A support frame covers the injection molded support member and the vibration unit.

The touch screen panel may be integrated with the image display.

The vibration unit may comprise a piezoelectric or polymer actuator or motor.

The vibration unit may comprise one single layer or a plurality of layers.

In a touch screen device according to another embodiment of the present invention, a touch screen panel receives a touch signal from a user. An image display is provided under the touch screen panel to display images. The image display comprises a plurality of layers. An injection molded support member is attached at one side thereof to the periphery of the lower surface of the image display. A vibration unit is provided between the layers of the image display. The vibration unit generates vibrations depending on the touch signal. A to support frame covers the injection molded support member and the vibration unit.

The touch screen panel may be integrated with the image display.

The vibration unit may comprise a piezoelectric or polymer actuator or motor.

The vibration unit may comprise one single layer or a plurality of layers.

In the touch screen device according to the present invention, a vibration unit is installed in a space formed between an image display and a support frame or under the image display or on the periphery of the image display. Therefore, vibrational force generated from the vibration unit can be directly applied to the image display.

Vibrational force which is applied to the image display is directly transmitted to a touch screen panel which is placed on the image display. Therefore, the vibrational force can be directly transferred to the user without a loss of vibrational force attributable to the medium.

Thus, because the efficiency of transmission of vibrations is increased by eliminating intermediate loss, the vibration unit can be manufactured smaller in size. In particular, in the case of a piezoelectric actuator which is expensive, the effect of reducing the production cost can be markedly increased by the present invention.

Furthermore, because the vibration unit is disposed in a space formed between the image display and the support frame, the vibration unit can be prevented from being affected by deformation of the support frame due to external force.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a touch screen device, according to a first embodiment of the present invention;

FIG. 2 is a sectional view illustrating the touch screen device according to the first embodiment of the present invention;

FIG. 3 is a sectional view illustrating a touch screen device, according to a second embodiment of the present invention; and

FIG. 4 is a view showing the state of the touch screen device when touched by a user's finger according to the first embodiment of the present invention.

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, preferred embodiments of the present invention will be described in detail with reference to the attached drawings.

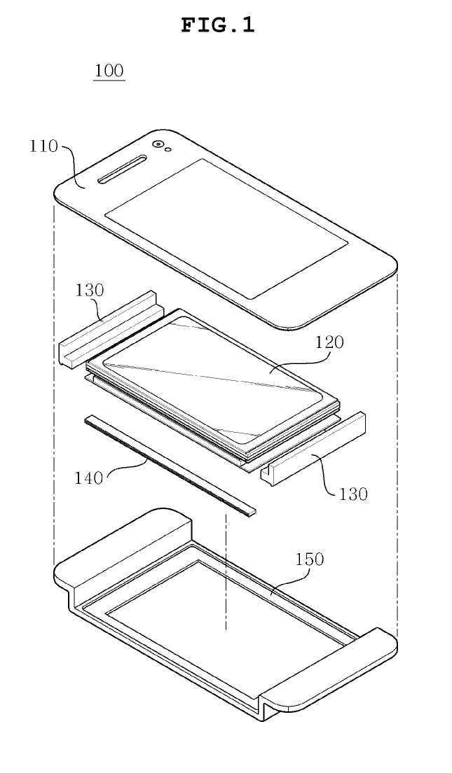

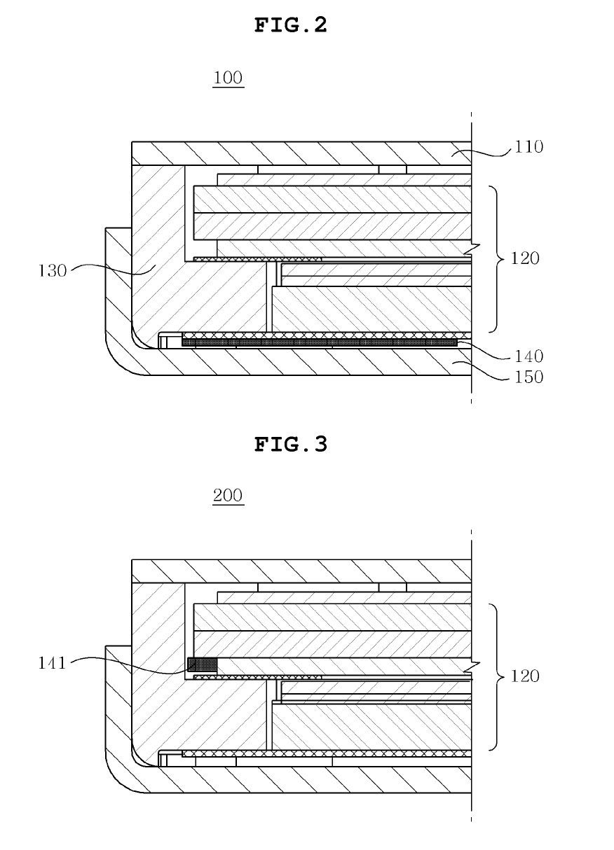

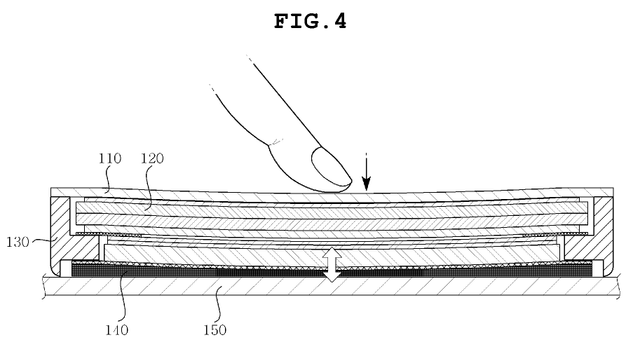

FIGS. 1 and 2 illustrate a touch screen device 100 according to a first embodiment of the present invention. The touch screen device 100 includes a touch screen panel 110, an image display 120, injection molded support members 130, a vibration unit 140 and a support frame 150.

The touch screen panel 110 is transparent and flexible and functions as a signal input surface which enables a user to observe an image displayed on the image display 120 and press it to input a signal. For instance, the touch screen panel 110 has a rectangular shape which extends a predetermined length in the longitudinal direction of the touch screen device 100.

The image display 120 converts a variety of electrical information provided by various units into visual information using the variation of transmittance of a liquid crystal to which depends on applied voltage. The image display 120 is mounted under the touch screen panel 110 and comprises one or more layers.

In the touch screen device 100 of the present invention, the image display 120 may be integrally coupled to the lower surface of the touch screen panel 110. A user observes an image expressed on the image display 120 and touches a desired portion of the touch screen panel 110 to input the information he/she desires to input. Then, an image corresponding to the input information is displayed on the image display 120.

In the case of the structure in which the touch screen panel 110 is integrated with the image display 120, the productivity and the strength against impact are increased, compared to those of the conventional structure in which the touch screen panel 110 and the image display 120 are provided separately from each other.

The touch screen panel 110 is made, for example, by laminating an outer film, an ITO (indium tin oxide) film and a base film.

In detail, the outer film is disposed on a front surface of a mobile communication terminal and is sectioned into a viewing area within which touch input is available, and a dead space area which is formed around the viewing area. The outer film is made of transparent film material, such as PET (poly ethylene terephthalate), to allow the user to observe the image display 120 through the outer film.

The ITO film is formed by laminating two upper and lower film layers, although it is not in detail shown in the drawings. A dot spacer is interposed between the upper and lower film layers of the ITO film to maintain the distance therebetween constant. An electrode membrane having an X-axis pattern and a Y-axis pattern is provided on the perimeter of each film layer. The X-axis pattern and the Y-axis pattern are electrically separated from each other by an insulator (not shown). The electrode membrane is exposed outside the ITO film through an FPC (flexible printed circuit) cable and is electrically connected to the mobile communication terminal.

The base film supports the entire touch panel. For example, a glass substrate having superior transmissivity and a high touch response speed can be used as the base film.

The injection molded support members 130 provide a space in which the vibration unit 140 is installed and function as a vibration transmission plate which transmits vibrations generated from the vibration unit 140 to the touch screen panel 110. Each injection molded support member 130 is attached at one surface thereof to the perimeter of the lower surface of the image display 120 and has a stepped portion which extends a predetermined distance from the lower portion of the inner surface thereof inwards in the horizontal direction.

The vibration unit 140 is installed in the space formed by the lower stepped portions of the injection molded support members 130.

The vibration unit 140 functions to generate vibrations and apply them to the touch screen panel 110. The vibration unit 140 is disposed under the image display 120 to directly transmit vibrations generated as a result of touching to the image display 120.

Here, the vibration unit 140 which generates vibrations must be disposed in the space formed between the image display 120 and the support frame 150. In consideration of this, the vibration unit 140 is made of a piezoelectric (or polymer) actuator or motor which can be formed thin and generate vibrations in such a way that it is expanded and contracted by external power in the longitudinal direction.

In the touch screen device 100 according to the first embodiment of the present invention, the vibration unit 140 may have one single layer structure or, alternatively, may have a structure formed by laminating several layers. Preferably, the vibration unit 140 is mounted under the image display 120.

The support frame 150 covers the lower surfaces and peripheries of the injection molded support members 130 and the vibration unit 140 to protect them from external impact.

In the present invention, because the vibration unit 140 is mounted under the image display 120, vibrations generated form the vibration unit 140 can be directly transmitted to the image display 120 regardless of the support frame 150.

Therefore, the present invention can solve a problem of the vibrational force transmitted to the image display 120 being reduced due to the thickness of the support frame 150 when the vibration unit 140 is mounted under the support frame 150. Furthermore, the transmission of vibrations is prevented from being affected by the thickness of a vibration transmission media, such as the support frame 150, and also by bending of the support frame 150.

FIG. 3 is a sectional view showing a touch screen device 200 according to a second embodiment of the present invention. As can be appreciated from FIG. 3, the general structure of the touch screen device 200 according to the second embodiment, with the exception of the installation position of a vibration unit 141, remains the same as that of the touch screen device 100 of the first embodiment. Therefore, a similar explanation of the same structure will be omitted.

As shown in FIG. 3, in the touch screen device 200 according to the second embodiment of the present invention, the vibration unit 141 is installed between the layers of an image display 120.

Here, the vibration unit 141 comprises a piezoelectric (or polymer) actuator or motor, so that it can be formed thin (on the μM scale).

Furthermore, the vibration unit 141 can be installed between the layers of the image display 120. Hence, vibrations generated from the vibration unit 141 can be directly transmitted to the image display 120, and the vibration can also be directly transmitted to the touch screen panel 110 which is placed on the image display 120.

As such, because the vibration unit 141 of the touch screen device 200 according to the second embodiment is disposed between the layers of the image display 120, the thickness of the portion of the image display 120 which is above the vibration unit 141 is reduced. Hence, the efficiency of transmitting vibrations from the vibration unit 141 to the touch screen panel 110 which is placed on the image display 120 can be enhanced.

Moreover, in the second embodiment, the vibration unit 140 is disposed in the image display 120 and generates vibrations in the image display 120. Therefore, preferably, the vibration unit 140 comprises a piezoelectric (or polymer) actuator or motor which can be formed thin and generate vibrations in such a way that it is expanded and contracted by external force in the longitudinal direction.

Meanwhile, the vibration unit 141 of the touch screen device 200 according to the second embodiment may have one single layer structure or, alternatively, a structure formed by laminating several layers. Preferably, the vibration unit 141 is installed between the layers of the image display 120.

As described above, the vibration unit 140, 141 of the touch screen device 100 according to the present invention is installed in a space formed between the image display 120 and the support frame 150 or under the image display 120 or on the periphery of the image display 120. Therefore, vibrational force generated from the vibration unit 141 can be directly applied to the image display 120.

Vibrational force which is applied to the image display 120 is directly transmitted to the touch screen panel 110 which is placed on the image display 120. Therefore, the vibrational force can be directly transferred to the user without a loss of vibrational force attributable to the medium.

As such, because the efficiency of transmission of vibrations is increased by eliminating intermediate loss, the vibration unit 141 can be manufactured smaller in size. In particular, in the case of a piezoelectric actuator which is expensive, the effect of reducing the production cost can be markedly increased by the present invention.

Furthermore, because the vibration unit 140 is disposed in a space formed between the image display 120 and the support frame 150, the vibration unit 140 can be prevented from being affected by deformation of the support frame 150 due to external force.

Although the embodiments of the present invention have been disclosed for illustrative purposes, it will be appreciated that a touch screen device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen device, comprising:
a touch screen panel receiving a touch signal from a user;
an image display provided under the touch screen panel to display images, the image display comprising a plurality of layers;
an injection molded support member attached at one side thereof to a periphery of a lower surface of the image display;
a vibration unit mounted under the image display, the vibration unit generating to vibrations depending on the touch signal; and
a support frame covering the injection molded support member and the vibration unit.

2. The touch screen device as set forth in claim 1, wherein the touch screen panel is integrated with the image display.

3. The touch screen device as set forth in claim 1, wherein the vibration unit comprises a piezoelectric or polymer actuator or motor.

4. The touch screen device as set forth in claim 1, wherein the vibration unit comprises one single layer or a plurality of layers.

5. A touch screen device, comprising:
a touch screen panel receiving a touch signal from a user;
an image display provided under the touch screen panel to display images, the image display comprising a plurality of layers;
an injection molded support member attached at one side thereof to a periphery of a lower surface of the image display;
a vibration unit provided between the layers of the image display, the vibration unit generating vibrations depending on the touch signal; and
a support frame covering the injection molded support member and the vibration unit.

6. The touch screen device as set forth in claim 5, wherein the touch screen panel is integrated with the image display.

7. The touch screen device as set forth in claim 5, wherein the vibration unit comprises a piezoelectric or polymer actuator or motor.

8. The touch screen device as set forth in claim 5, wherein the vibration unit comprises one single layer or a plurality of layers.
